(19) United States
(12) Patent Application Publication
(10) Pub. No.: US 2008/0077916 A1
(43) Pub. Date: Mar. 27, 2008

(54) Virtual heterogeneous channel for message passing

(76) Inventors: Alexander V. Supalov, Erftstadt (DE); Vladimir D. Truschin, Sarov (RU); William R. Magro, Champaign, IL (US)

Correspondence Address: TROP PRUNER & HU, PC, 1616 S. VOSS ROAD, SUITE 750, HOUSTON, TX, 77057-2631, US

(21) Appl. No.: 11/528,201

(22) Filed: Sep. 27, 2006

(51) Int. Cl. G06F 9/455; G06F 9/46

(52) U.S. Cl. 718/1; 719/312

(57) ABSTRACT

A technique includes using a virtual channel between a first process and a second process to communicate messages between the processes. Each message contains protocol data and user data. All of the protocol data is communicated over a first channel associated with the virtual channel, and the user data is selectively communicated over at least one other channel associated with the virtual channel.

### BACKGROUND

The invention generally relates to a virtual heterogeneous channel for message passing.

Processes typically communicate through internode or intranode messages. There are many different types of standards that have been formed to attempt to simplify the communication of messages between processes. One such standard is the message passing interface (called “MPI”). MPI: A Message-Passing Interface Standard, Message Passing Interface Forum, May 5, 1994; and MPI-2: Extension to the Message-Passing Interface, Message Passing Interface Forum, Jul. 18, 1997. MPI is essentially a standard library of routines that may be called from programming languages, such as FORTRAN and C. MPI is portable and typically fast due to optimization of the platform on which it is run.

### BRIEF DESCRIPTION OF THE DRAWING

FIG. 1 is a schematic diagram of a system according to an embodiment of the invention.

FIG. 2 is a schematic diagram of a software architecture associated with a process of FIG. 1 according to an embodiment of the invention.

FIG. 3 is a flow diagram depicting a technique to communicate between two processes using a virtual heterogeneous channel according to an embodiment of the invention.

FIG. 4 is a flow diagram depicting a technique to initialize the virtual heterogeneous channel according to an embodiment of the invention.

FIG. 5 is a flow diagram depicting a technique to transmit a message over the virtual heterogeneous channel according to an embodiment of the invention.

FIG. 6 is a flow diagram depicting a technique to receive a message from the virtual heterogeneous channel according to an embodiment of the invention.

FIGS. 7, 8 and 9 illustrate the performance of the virtual heterogeneous channel for different message sizes when the channel uses InfiniBand architecture in accordance with an embodiment of the invention.

FIGS. 10, 11 and 12 depict illustrate the performance of the virtual heterogeneous channel for different message sizes when the channel uses a direct Ethernet transport in accordance with an embodiment of the invention.

### DETAILED DESCRIPTION

In accordance with embodiments of the invention described herein two processes communicate messages with each other using a virtual heterogeneous channel. The virtual heterogeneous channel provides two paths for routing the protocol and user data that is associated with the messages: a first channel for routing all of the protocol data and some of the user data; and a second channel, for routing the rest of the user data. As described below, in some embodiments of the invention, the selection of the channel for communicating the user data may be based on the size of the message or some other criteria. The virtual heterogeneous channel may be used for intranode communication or internode communication, depending on the particular embodiment of the invention.

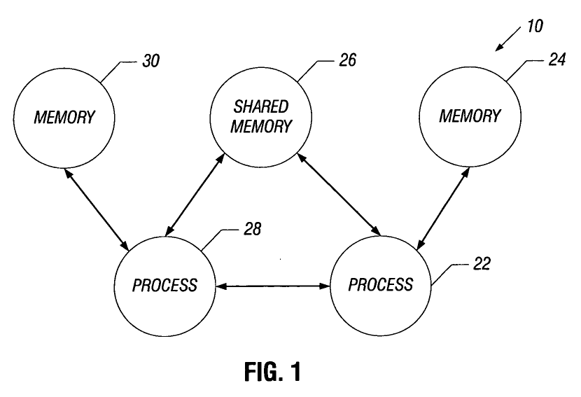

As a more specific example, FIG. 1 depicts an exemplary system 10 in which two processes 26 and 28 establish and use a virtual heterogeneous channel for purposes of intranode communication of messages in accordance with some embodiments of the invention. The processes 22 and 28 have access to a shared memory 26, which forms a shared memory channel (of the virtual heterogeneous channel) to communicate all message protocol data, an approach that maintains an order to the communication of messages between the processes 22 and 28, regardless of the channel that is used for communication of the associated user data. For a relatively small message, the shared memory channel also is used to communicate the user data of the message. In accordance with some embodiments of the invention, for a small message, the use of the shared memory channel may be similar to an “eager” protocol in which both the envelope and the payload data of the message are communicated at the same time from one process 22, 28 to the other. Thus, the shared memory 26 may serve as a temporary buffer for storing an incoming message for the process 22, 28 before the process 22, 28 has the available storage or processing capability to retrieve the message from the shared memory 26.

For larger messages, however, the shared memory channel may be relatively inefficient for purposes of communicating user data, and as a result, the processes 22 and 28, in accordance with embodiments of the invention described herein, use a technique that is better suited for these larger messages. More specifically, a higher bandwidth channel for larger message sizes is used for purposes of communicating the user data for large messages. In accordance with some embodiments of the invention, a Direct Access Programming Library (DAPL) channel may be used to communicate larger messages. The DAPL establishes an interface to DAPL transports, or providers. An example of the Direct Ethernet Transport (DET).

Other architectures are within the scope of the appended claims. For example, in some embodiments of the invention, InfiniBand Architecture with RDMA capabilities may be used. The InfiniBand Architecture Specification Release 1.2 (October 2004) is available from the InfiniBand Trade Association at www.infinibandta.org. The DAPL channel has an initial large overhead that is attributable to setting up the user data transfer, such as the overhead associated with programming the RDMA adaptor with the destination address of the user data. However, after the initial setup, a data transfer through the DAPL channel may have significantly less latency than its shared memory channel counterpart.

More particularly, using the DAPL channel, one process 22, 28 may transfer the user data of a message to the other process 22, 28 using zero copy operations in which data is copied directly into a memory 24, 30 that is associated with the process 22, 28. The need to copy data between application memory buffers associated with the processes 22, 28 is eliminated, as the DAPL channel may reduce the demand on the host central processing unit(s) CPU(s) because the CPU(s) may not be involved in the DAPL channel transfer.

Due to the above-described latency characteristics of the DAPL and shared memory channels, in accordance with embodiments of the invention described herein, for smaller messages, the user data is communicated through the shared memory channel and for larger messages, the user data is communicated through the DAPL channel. It is noted that because the shared memory channel communicates all message protocol data (regardless of message size), ordering of the messages is preserved.

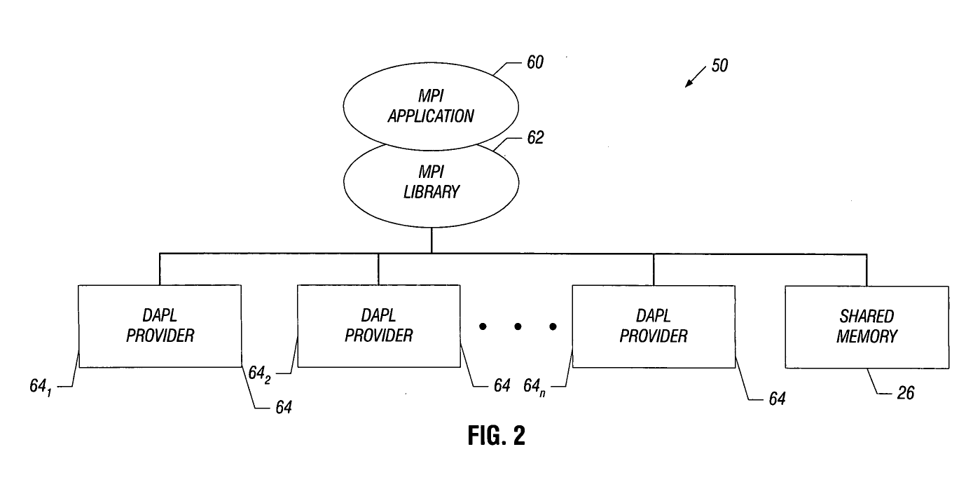

FIG. 2 generally depicts an exemplary software architecture 50 that may be used by each of the processes 22 and 28 in accordance with some embodiments of the invention. The architecture 50 includes a message processing interface (MPI) application layer 60 and an MPI library 62. A process, via the execution of the MPI application layer 60, may generate a message that contains user data that may, via the MPI library 62, be communicated to another process through either the shared memory or through a DAPL provider 64 (DAPL providers 64₁, 64₂ . . . 64ₙ, being depicted as examples); and the associated protocol data is communicated via the shared memory 26.

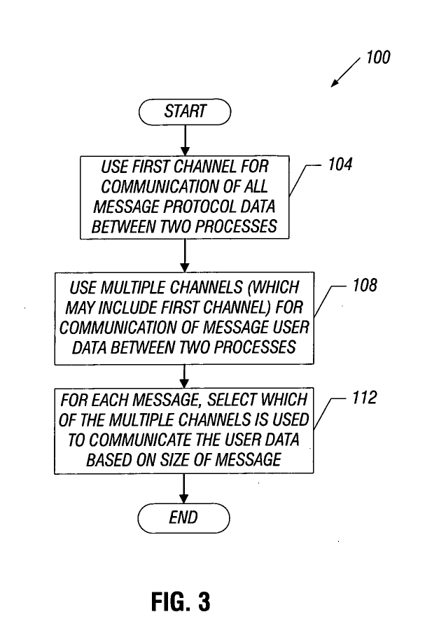

Referring to FIG. 3, to summarize, a technique 100 to communicate a message between two processes includes using (block 104) a first channel to communicate all message protocol data between the two processes and using (block 108) multiple channels to communicate the message user data between the two processes. It is noted that these multiple channels may include the first channel that is also used to communicate all of the message protocol data, in accordance with some embodiments of the invention. Pursuant to block 112, for each message, one of the multiple channels is selected and used to communicate the user data based on the size of the message.

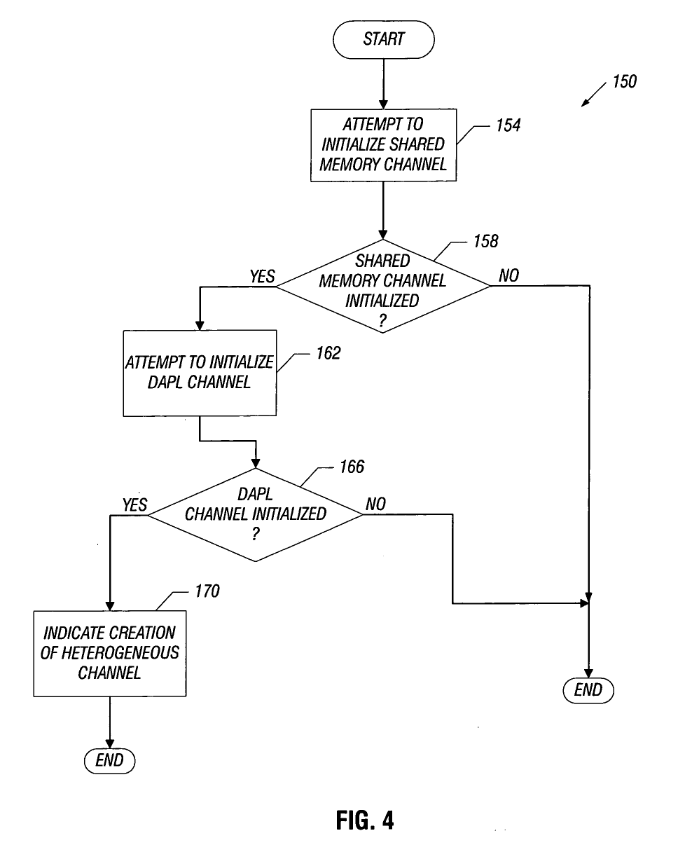

In accordance with some embodiments of the invention, the above-described virtual heterogeneous channel may be created by a process using a technique 150 that is depicted in FIG. 4. Pursuant to the technique 150, a process attempts (block 154) to initiate a shared memory channel. If the process is successful in initializing the shared memory channel (pursuant to diamond 158), then the process attempts (block 162) to initialize a DAPL channel. If the process is successful in initializing the DAPL channel (pursuant to diamond 166), then the process indicates (block 170) creation of the virtual heterogeneous channel.

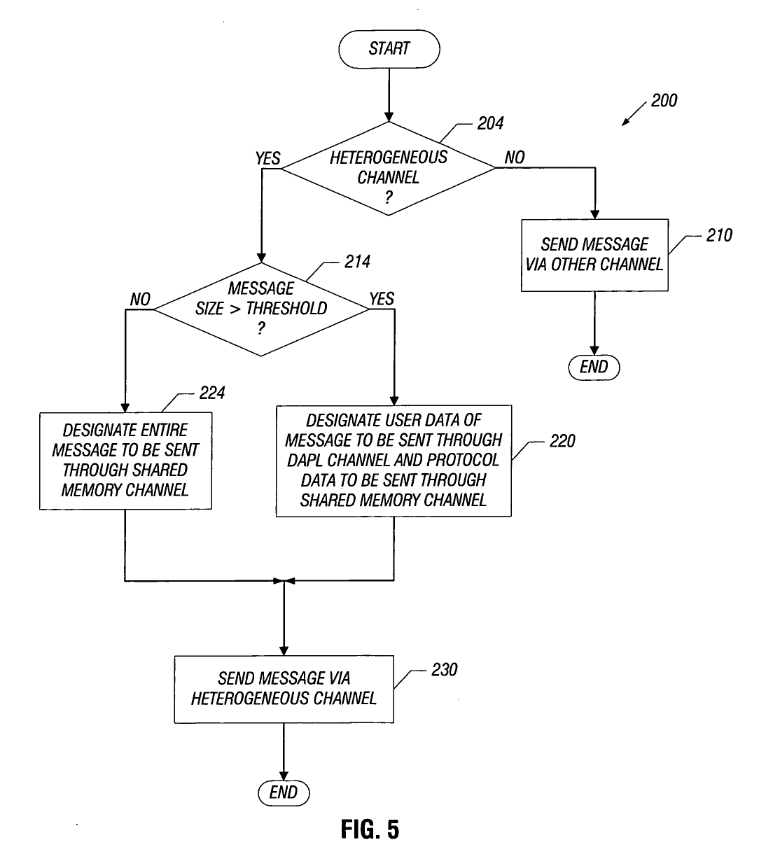

A process may transmit a message using the virtual heterogeneous channel pursuant to a technique 200 that is depicted in FIG. 5, in accordance with some embodiments of the invention. Pursuant to the technique 200, the process first determines (diamond 204) whether a virtual heterogeneous channel exists. If not, the process sends (block 210) the message via another channel. Otherwise, the process proceeds with the transmission via the virtual heterogeneous channel.

Assuming a virtual heterogeneous channel exists, the process determines (diamond 214) whether a size that is associated with the message is greater than a particular value of a threshold. If so, then the process designates the user data of the message to be sent through the DAPL channel and the protocol data to be sent through the shared memory channel, pursuant to block 220. Otherwise, if the message size is less than the value of the threshold, the process designates the entire message to be sent through the shared memory channel, pursuant to block 224. Subsequently, the message is sent via the virtual heterogeneous channel, pursuant to block 230.

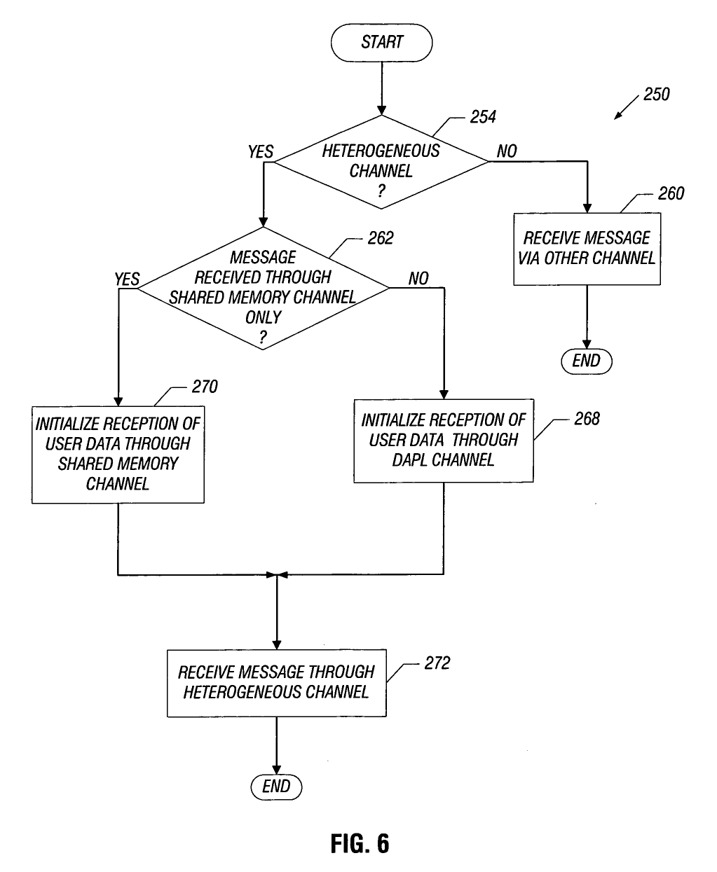

For purposes of receiving a message via the virtual heterogeneous channel, a process may use a technique 250, which is depicted in FIG. 6. Pursuant to the technique 250, the process determines (diamond 254) whether a virtual heterogeneous channel exists. If not, then the message is received via another channel, pursuant to block 260.

Otherwise, if a virtual heterogeneous channel exists, then the process determines (diamond 262) whether the message received is through the shared memory channel only. If so, then the process initializes (block 270) the reception of the user data through the shared memory channel. It is noted that the protocol data is always transmitted through the shared memory channel. If the message is not received only through the shared memory channel, then the process initializes (block 268) the reception of the user data through the DAPL channel. After the reception of the message has been initialized, the process receives the message through the heterogeneous channel, pursuant to block 272.

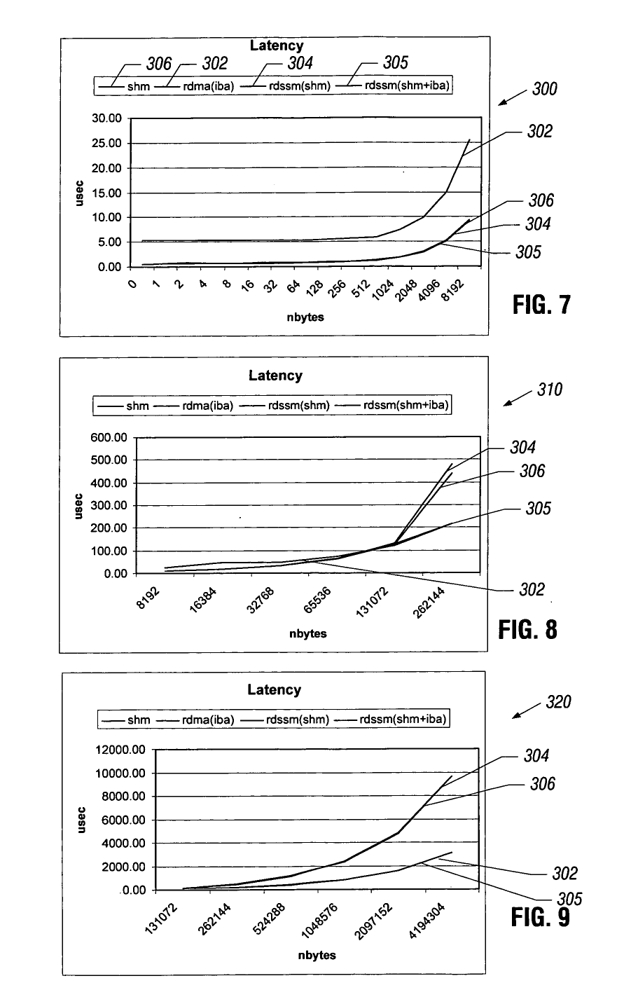

FIGS. 7, 8 and 9 depict latency comparisons 300, 310 and 320 (that include the virtual heterogeneous channel) for three different message sizes. For this example, the heterogeneous channel uses InfiniBand architecture for the larger message sizes. Four different latencies are depicted in FIGS. 7, 8 and 9: a latency 306 associated with a dedicated unifabric shared memory device; a latency 302 associated with a dedicated unifabric RDMA device; a latency 304 associated a multifabric device operated in shared memory mode; and a latency 305 associated with the virtual heterogeneous channel in accordance with embodiments of the invention described herein. FIG. 7 is associated with the smallest message sizes; FIG. 8 is associated with intermediate message sizes; and FIG. 9 is associated with the largest message sizes.

As depicted in FIG. 7, for smaller message sizes, the latency 302 associated with a dedicated unifabric RDMA device, has the largest latency, due to the relative overhead associated with setting up the data transfer. It is noted that the latency 305, associated with the virtual heterogeneous channel, is approximately the same as the latencies 304 and 306.

Referring to FIG. 8, for intermediate-sized messages, the latency 305 generally follows the latency 302 associated with the dedicated unifabric RDMA device as generally being the lowest latency. The latencies 304 and 306, associated with shared memory communication, are the highest latencies. This trend continues in FIG. 9, in which the latencies 304 and 306 are the highest, and the latencies 302 and 305, once again, are the lowest.

Thus, as can be seen from FIGS. 7-9, the latency 305 associated with the virtual heterogeneous channel is the lowest for each range of message sizes.

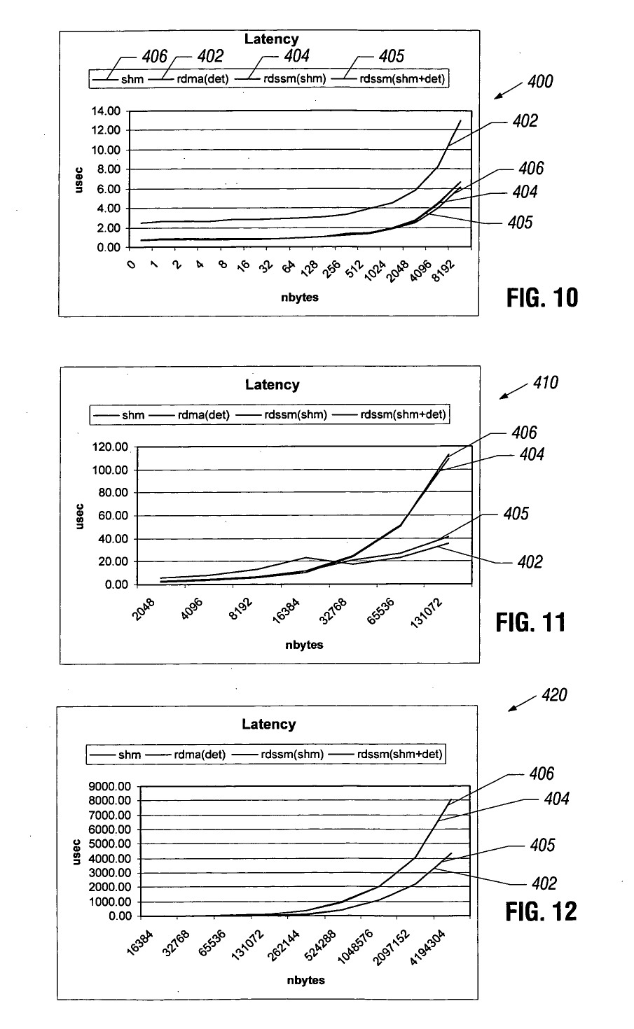

FIGS. 10, 11 and 12 depict latency comparisons 400, 410 and 420 (that include the virtual heterogeneous channel) for three different message sizes. For this example, the virtual heterogeneous channel uses the direct Ethernet transport (DET) for the larger message sizes. Four different latencies are depicted in FIGS. 10, 11 and 12: a latency 406 for a dedicated unifabric shared memory device; a latency 402 for a dedicated unifabric DET device; a latency 404 for an original multifabric device in shared memory mode; and a latency 405 associated with the virtual heterogeneous channel. Similar to FIGS. 7-9, FIGS. 10-11 depict that for each message size range, the latency 405 associated with the virtual heterogeneous channel is the lowest.

Other embodiments are within the scope of the appended claims. For example, in accordance with other embodiments of the invention, the selection of the channel for communicating the user data may be based on criteria other than message size. More specifically, every n-th message may be sent through the DAPL channel for purposes of balancing the load between the DAPL and shared memory channels.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A method comprising:
using a virtual channel between a first process and a second process to communicate messages between the processes, each message containing protocol data and user data, the virtual channel associated with a first channel and a second channel;
communicating all of the protocol data over a first channel; and
selectively communicating the user data over the second channel.

2. The method of claim 1, wherein selectively communicating comprises:
determining whether to communicate the user data of a given message over one of the first and second channels based on a size associated with the given message.

3. The method of claim 1, wherein communicating the protocol data comprises transmitting at least some of the protocol data.

4. The method of claim 1, wherein communicating the protocol data comprises receiving at least some of the data.

5. The method of claim 1, wherein communicating the protocol data comprises communicating all of the protocol data over a shared memory channel.

6. The method of claim 1, wherein the using comprises using one internode and intranode communication.

7. The method of claim 1, wherein selectively communicating the user data comprises:
selectively using a direct access programming library channel to communicate the user data.

8. The method of claim 1, wherein selectively communicating comprises:
determining whether to communicate the user data of a given message over one of the first and second channels based on a criterion other than a size associated with the given message.

9. A system comprising:
a virtual channel associated with a first channel and a second channel; and
a process to:
communicate messages with another process via the virtual channel, each message comprising protocol data and user data;
communicate all of the protocol data over the first channel; and
selectively communicate the user data over the first and second channels.

10. The system of claim 9, wherein the process determines whether to communicate the user data of a given message over one of the first channel and the second channel based on a size associated with the given message.

11. The system of claim 9, wherein the first channel comprises a shared memory channel.

12. The system of claim 9, wherein the processes are located on different nodes.

13. The system of claim 9, wherein the process selectively communicates the user data over a shared memory channel and a direct programming access library channel.

14. The system of claim 9, wherein the process receives and transmits messages over the virtual channel.

15. The system of claim 8, wherein the process determines whether to communicate the user data of a given message over one of said at least one other channel and the first channel based on a loading associated with the first and second channels.

16. An article comprising a computer accessible storage medium storing instructions that when executed by a processor-based system cause the processor-based system to:
use a virtual channel between a first process and a second process to communicate messages between the processes, each message containing protocol data and user data;
communicate all of the protocol data over a first channel associated with the virtual channel; and
selectively commuinicate the user data over at least one other channel associated with the virtual channel.

17. The article of claim 16, the storage medium storing instructions that when executed cause the processor-based system to:
determine whether to communicate the user data of a given message over one of said at least one other channel and the first channel based on a size associated with the given message.

18. The article of claim 16, the storage medium storing instructions that when executed cause the processor-based system to:
communicate all of the protocol data over a shared memory channel.

19. The article of claim 16, wherein the connection comprises one of an internode connection and an intranode connection.

20. The article of claim 16, the storage medium storing instructions that when executed cause the processor-based system to:
selectively use a direct access programming library channel to communicate the user data.

21. The article of claim 16, the storage medium storing instructions that when executed cause the processor-based system to:
determine whether to communicate the user data of a given message over one of said at least one other channel and the first channel based on a criterion other than a size associated with the given message.
